(19) United States
(12) Patent Application Publication
(10) Pub. No.: US 2009/0222725 A1
(43) Pub. Date: Sep. 3, 2009

(54) METHOD AND APPARATUS FOR INPUT ASSISTANCE

(75) Inventor: Masahide ARIU, Yokohama-shi (JP)

Correspondence Address: Ohlandt, Greeley Ruggiero & Perle, L.L.P, 10th Floor, One Landmark Square,, Stamford, CT, 06901-2682, US

(73) Assignee: KABUSHIKI KAISHA TOSHIBA

(21) Appl. No.: 12/389,209

(22) Filed: Feb. 19, 2009

(30) Foreign Application Priority Data
Feb. 20, 2008 (JP) 2008-039121

(51) Int. Cl. G06F 3/048; G06F 3/01

(52) U.S. Cl. 715/702; 715/764; 715/727

(57) ABSTRACT

An input assistance apparatus includes a generation unit configured to generate from input content data a first input candidate that has first notation data, a storage unit configured to store reference data, the reference data including reference data components, each reference data components including second notation data representing a notation of the reference data component and ordinal data representing a time position of the reference data component in the reference data, the second notation data being stored in association with the ordinal data, a storage unit configured to store an input history including the notation data, the ordinal data associated with the notation data and the input position data, an estimation unit configured to estimate a retrieval range for the reference data, from the input position data and the input history, and a generation unit configured to retrieve, from the retrieval range, and to generate a second input candidate.

### CROSS-REFERENCE TO RELATED APPLICATIONS

This application is based upon and claims the benefit of priority from prior Japanese Patent Application No. 2008-039121, filed Feb. 20, 2008, the entire contents of which are incorporated herein by reference.

### BACKGROUND OF THE INVENTION

1. Field of the Invention

The present invention relates to an input assistance apparatus and an input assistance method, both designed to display input candidates to a user, assisting the user to input data.

2. Description of the Related Art

A user may input data to a computer or a cellular phone, in the form of communication means such characters, speech or gestures. Then, in accordance with the communication means, data recognition technique, such as character recognition, speech recognition or image recognition, is utilized, thereby correctly inputting the data. An input assistance technique is being searched and developed, which can predict the data that the user may input next, from a part of the data the user has already input, thereby to increase the data input efficiency.

JP-A 2005-301699 (KOKAI) describes a character input apparatus into which data is input in units of words and which can retrieve some candidate phrases (combinations of words) from a phrase dictionary and display the candidate phrases retrieved, each candidate phrase being one that may possibly precede or follow the word the user has just input. Therefore, if the candidate phrases include the phrase the user wants to input, the user only need to select that phrase in order to input the same. Since the user can input the phrase, merely by selecting the phrase, the data input efficiency is far higher than in the case where the user inputs the phrase, character by character.

In the character input apparatus described in JP-A 2005-301699 (KOKAI), the accuracy of predicting what will be input next depends on the phrase dictionary used to predict the next input. The apparatus described in JP-A 2005-301699 (KOKAI) cannot reliably generate input candidates if the phrase that should precede or follow any phrase the user has input is different from those contained in the phrase dictionary.

JP-A H8-329057 (KOKAI) describes an input assistance apparatus that predicts the data that will be input next, from not only the data the user has just input, but also the position on a document, at which the data has input. More precisely, the input assistance apparatus described in JP-A H8-329057 (KOKAI) changes the priority of the input candidates obtained in accordance with the data the user has just input, in accordance with the position at which the data has just been input, thereby increasing the accuracy of predicting the data to input next. In the apparatus described in JP-A H8-329057 (KOKAI), if data should be next input in an address column on a document, the priority of any input candidate pertaining to an address will be increased.

In the input assistance apparatus described in JP-A H8-329057 (KOKAI), the priority of the input candidate is changed in accordance with the input position. Therefore, with the input assistance apparatus described in JP-A H8-329057 (KOKAI), the accuracy of predicting the input candidate cannot be increased unless the input position, such as an address, is associated with the input candidate.

The user may input data while listening to a lecturer or an announcer, while referring to the data the lecturer or announcer is presented to him or her. In this case, the data presented can be used, thereby to raise the accuracy of predicting the data that should be input next.

JP-A 2007-18290 (KOKAI) describes a method of predicting a character string, in which the recognized characters the user has input are used to retrieve reference data that is the recognized speech of a speaker, and words including the recognized characters are displayed to the user as input candidates. In the method described in JP-A 2007-18290 (KOKAI), the characters that may be input next can be predicted in accordance with the characters the user has just input.

In the method described in JP-A 2007-18290 (KOKAI), input candidates are acquired by using the recognized characters the user has input, thereby to retrieve reference data that is the recognized speech of a speaker. Thus, in the method described in JP-A 2007-18290 (KOKAI), if a character the user has input is a Chinese character, a candidate may be obtained, which is identical to the character input by the user, but not in pronunciation.

Moreover, with the character string predicting method described in JP-A 2007-18290 (KOKAI) it is necessary to retrieve the entire reference data every time an input candidate is generated. On the other hand, if the user inputs data while listening to a lecturer or an announcer, while referring to the data the lecturer or announcer is presented to him or her, the reference data items inputs in time sequence (in an order) tend to be related with the spatial data items the user inputs. That is, such relation is not taken into account in the character string predicting method described in JP-A 2007-18290 (KOKAI), and redundant retrieval is inevitably performed. The greater the amount of reference data, the larger the load of the retrieval process will be. The character predicting method described in JP-A 2007-18290 (KOKAI) can indeed use, as reference data, the speech recognized in the latest specific period. Even in this case, however, the entire reference data must be retrieved every time an input candidate is generated.

### BRIEF SUMMARY OF THE INVENTION

According to an aspect of the invention, there is provided an input assistance apparatus comprising: a detection unit configured to detect input content data representing content of a user input on a user interface and input position data representing position of a user input on the user interface; a first generation unit configured to generate from the input content data a first input candidate that has first notation data; a first storage unit configured to store reference data for the user input, the reference data including reference data components, each reference data components including second notation data representing a notation of the reference data component and ordinal data representing a time position of the reference data component in the reference data, the second notation data being stored in association with the ordinal data; a second storage unit configured to store an input history when the notation data about a user input made in the past is the second notation data, the input history including the notation data, the ordinal data associated with the notation data and the input position data; an estimation unit configured to estimate a retrieval range including in part of the reference data, based on the input position data and the input history; a second generation unit configured to retrieve, from the reference data components included in the retrieval range, at least one reference data component having the second notation data identical at least in part to the first notation data, and to generate at least one second input candidate having the ordinal data associated with the retrieved second notation data; a presentation unit configured to select at least one input candidate from the first input candidate and second input candidate and to present to the user the selected input candidate; and a receiving unit configured to receive a selection of a determined input from the presented input candidate coming from the user and to update the input history based on the determined input.

According to another aspect of the invention, there is provided an input assistance apparatus comprising: a detection unit configured to detect a user input including input content data and input position data, each representing content and space position, respectively; a first generation unit configured to generate from the input content data at least one first input candidate that has first notation data and first pronunciation data; a first storage unit configured to store reference data for the user input, the reference data including reference data components, each reference data components including second notation data representing a notation of the reference data component, second pronunciation data representing a pronunciation of the reference data component and ordinal data representing a time position of the reference data component in the reference data, the second notation data and the second pronunciation data being stored in association with the ordinal data; a second storage unit configured to store an input history when the pronunciation data about a user input made in the past is the second pronunciation data, the input history including the pronunciation data, the ordinal data associated with the pronunciation data, and the input position data; an estimation unit configured to estimate a retrieval range including in part of the reference data, based on the input position data and the input history; a second generation unit configured to retrieve, from the reference data components included in the retrieval range, at least one reference data component having the second pronunciation data identical at least in part to the first pronunciation data, and to generate at least one second input candidate having the retrieved second pronunciation data and the second notation data and ordinal data associated with the retrieved second pronunciation data; a presentation unit configured to select at least one input candidate from the first input candidate and second input candidate and to present to the user the selected input candidate; and a receiving unit configured to receive a selection of a determined input from the presented input candidate coming from the user and to update the input history based on the determined input.

### BRIEF DESCRIPTION OF THE SEVERAL VIEWS OF THE DRAWING

FIG. 1 is a block diagram showing an input assistance apparatus according to a first embodiment;

FIG. 2 is a diagram explaining the user interface of the input assistance apparatus shown in FIG. 1;

FIG. 3 is a flowchart explaining the operating sequence of the input assistance apparatus shown in FIG. 1;

FIG. 4A is a diagram showing an example of reference data that is used in the input assistance apparatus shown in FIG. 1;

FIG. 4B is diagram showing a result of the morphologic analysis performed on the reference data shown in FIG. 4A;

FIG. 4C is a diagram showing the detailed reference data that has been extracted from the reference data shown in FIG. 4A;

FIG. 4D is a diagram showing an exemplary content of the detailed reference data shown in FIG. 4C, which is stored in the detailed reference data storage unit shown in FIG. 1;

FIG. 5A is a diagram showing an example of the data displayed on the user interface shown in FIG. 2;

FIG. 5B is a diagram showing an example of the data displayed on the user interface shown in FIG. 2;

FIG. 5C is a diagram showing an example of the data displayed on the user interface shown in FIG. 2;

FIG. 6A is a diagram showing an input history that may be stored in the input history storage unit shown in FIG. 1;

FIG. 6B is a diagram showing a first input candidate that the first generation unit shown in FIG. 1 may generate;

FIG. 6C is a diagram showing a retrieval range that the estimation unit shown in FIG. 1 may estimate;

FIG. 6D is a diagram showing a second input candidate that the second generation unit shown in FIG. 1 may generate;

FIG. 6E is a diagram showing an input candidate the input candidate display unit shown in FIG. 1 may display;

FIG. 6F is a diagram showing an input history that may be acquired by updating the input history shown in FIG. 6A;

FIG. 7 is a flowchart explaining a method the estimation unit shown in FIG. 1 may perform;

FIG. 8 is a flowchart showing another method the estimation unit shown in FIG. 1 may perform;

FIG. 9 is a flowchart explaining a method of generating the second input candidate the second generation unit may perform;

FIG. 10A is a diagram explaining a process of determining the retrieval range shown in FIG. 9;

FIG. 10B is a diagram explaining a process of determining the retrieval range, which is different from the method shown in FIG. 10A;

FIG. 11 is a flowchart explaining in detail Step 201 shown in FIG. 3;

FIG. 12 is a flowchart explaining the operating sequence of an input assistance apparatus according to a second embodiment;

FIG. 13A is a diagram showing an example of the data displayed on the user interface of the input assistance apparatus according to the second embodiment;

FIG. 13B is a diagram showing an example of the data displayed on the user interface of the input assistance apparatus according to the second embodiment;

FIG. 13C is a diagram showing an example of the data displayed on the user interface of the input assistance apparatus according to the second embodiment;

FIG. 13D is a diagram showing an example of the data displayed on the user interface of the input assistance apparatus according to the second embodiment;

FIG. 14A is a diagram showing an input candidate the input candidate display unit shown in FIG. 1 may display in the input assistance apparatus according to the second embodiment;

FIG. 14B is a diagram showing an input candidate that has been acquired by updating the input candidate shown in FIG. 14A in response to an additional input;

FIG. 15A is a diagram showing detailed reference data that may be extracted by the detailed reference data extraction unit of an input assistance apparatus according to a third embodiment;

FIG. 15B is a diagram showing how the detailed reference data of FIG. 15A may be stored in the detailed reference data storage unit of the input assistance apparatus according to the third embodiment;

FIG. 16A is a diagram showing an example of the data displayed on the user interface of the input assistance apparatus according to the third embodiment;

FIG. 16B is a diagram showing an example of the data displayed on the user interface of the input assistance apparatus according to the third embodiment;

FIG. 16C is a diagram showing an example of the data displayed on the user interface of the input assistance apparatus according to the third embodiment;

FIG. 17A is a diagram showing an input history that may be stored in the input history storage unit of the input assistance apparatus according to the third embodiment;

FIG. 17B is a diagram showing a first input candidate generated by the first generation unit of the input assistance apparatus according to the third embodiment;

FIG. 17C is a diagram showing a retrieval range that may be estimated in by the estimation unit of the input assistance apparatus according to the third embodiment;

FIG. 17D is a diagram showing a second input candidate that may be generated by the second generation unit of the input assistance apparatus according to the third embodiment;

FIG. 17E is a diagram showing an input candidate that the input candidate display unit may display in the input assistance apparatus according the third embodiment;

FIG. 17F is a diagram showing an input history acquired by updating the input history shown in FIG. 17A;

FIG. 18 is a block diagram showing an input assistance apparatus according to a forth embodiment; and

FIG. 19 is a flowchart explaining an operating sequence of the input assistance apparatus shown in FIG. 18.

### DETAILED DESCRIPTION OF THE INVENTION

The embodiments of the present invention will be described with reference to the accompanying drawings.

### First Embodiment

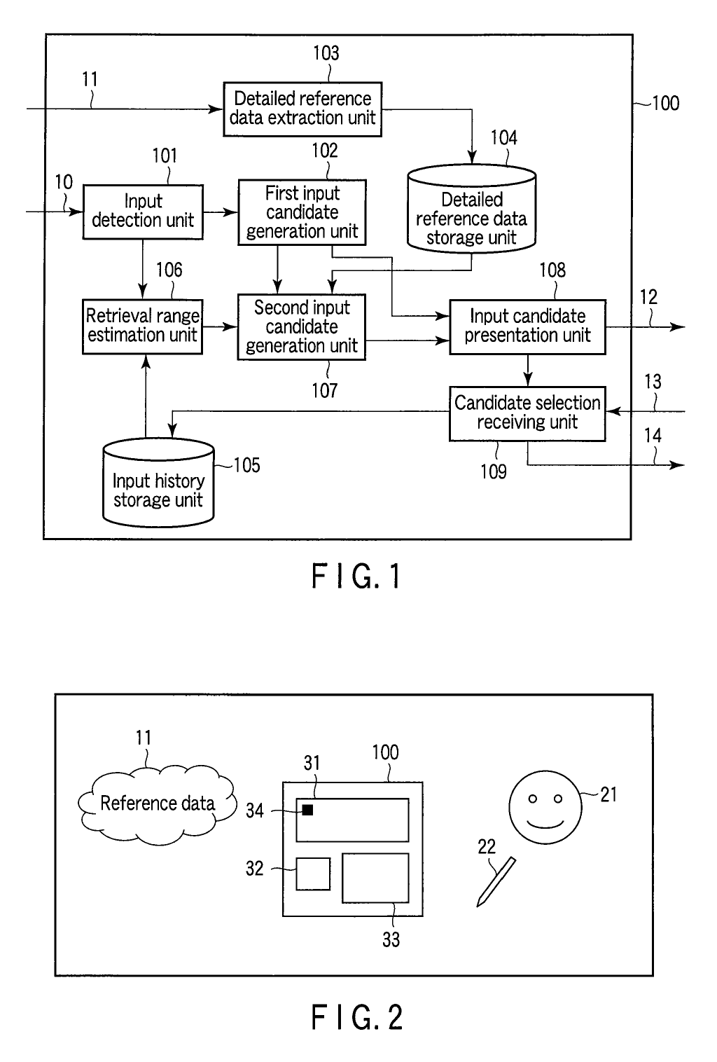

As FIG. 1 shows, an input assistance apparatus 100 according to the first embodiment of this invention comprises a detection unit 101, a first generation unit 102, detailed reference data extraction unit 103, a detailed reference data storage unit 104, an input history storage unit 105, an estimation unit 106, a second generation unit 107, a presentation unit 108, and a receiving unit 109.

The detection unit 101 detects input content data and input position data, which the user 21 inputs while referring to reference data 11. Then, the detection unit 101 inputs the input content data to the first generation unit 102, and the input position data to the estimation unit 106. Assume that the detection unit 101 holds the input content data and the input position data until the input is determined or until the input is initialized under prescribed conditions.

More specifically, the user interface of the input assistance apparatus 100 has the same configuration as the user interface for use in, for example, tablet type personal computers or personal digital assistants (PDAs). As shown in FIG. 2, the user interface has an input position designation/input display region 31, a character input region 32, and an input candidate display region 33. In the input position designation/input display region 31, a cursor 34 is displayed. Using a pointing device, the user 21 may move the cursor 34 to designate an input position.

Referring to the reference data 11, the user 21 uses an input device 22 such as a stylus pen or the like, inputting data in the character input region 32. When the input is determined as will be described later, the input is displayed at the position that the cursor 34 designates in the input position designation/input display region 31. In this instance, the detection unit 101 detects the content data input in the character input region 32 and the coordinates (row and column), as input content data and input position data, respectively. The following description is based on the assumption that the input data 10 is character data. Nonetheless, the input data 10 may instead be, for example, a speech input.

The first generation unit 102 recognizes the characters constituting the input data detected by the detection unit 101, thereby acquiring the notation of the input data 10. Then, the first generation unit 102 generates a first input candidate that accords with the notation. The first input thus generated is input to the second generation unit 107 and presentation unit 108. The configuration of the first generation unit 102 is not particularly limited. Nevertheless, it may be constituted by a program or a circuit that can accomplish the existing character recognition. The first generation unit 102 may generate a plurality of first input candidates, depending on the score of character recognition. The “score of character recognition” represents the likelihood or reliability at which any candidate coincides with the actual input. Moreover, the first generation unit 102 may output, as first input candidate, not only the notation of the input data, but also the score of character recognition. The following description is based on the assumption that both the notation of the input data and the score.

The detailed reference data extraction unit 103 extracts the detailed reference data from the reference data 11. The reference data 11 that the input assistance apparatus 100 of FIG. 1 processes is data that is temporal (ordinal) significant, such as speech data, text data, or video data. In other words, the reference data 11 is not merely a collection of phonemes, words and images. Assume that the reference data 11 is a text and that the detailed reference data includes the notation data about text components and the ordinal data of the text components. The text components are words. Instead, the phrases, each composed of words, may be processed as text components. The notations data of text components are symbols allocated to the respective components of the reference data 11. In the following description, the notation data represents the character notation of the input. The ordinal data represents the temporal order of the text components. An exemplary ordinal data item will be described later in detail. The input assistance apparatus 100 need not have the detailed reference data extraction unit 103 if it has been supplied with the detailed reference data.

The detailed reference data storage unit 104 stores the detailed reference data extracted by the detailed reference data extraction unit 103. More precisely, the detailed reference data storage unit 104 stores the notation data items of the words constituting the reference data 11 and the ordinal data associated with these notation data items. The detailed reference data storage unit 104 is a random access memory (RAM), in which the detailed reference data is stored at a specific position and from which the detailed reference data is read in response to a request externally made. The detailed reference data storage unit 104 may alternatively a storage circuit or a recording medium that can be random accessed.

The input history storage unit 105 stores an input history. The input history includes at least the input position data about any determined input 14 made in the past and the notation data of the determined input 14. If the determined input 14 has been selected from the second input candidate (described later), the input history includes the ordinal data representing the order of notation data items. If a plurality of ordinal data items are associated with the notation data, the input history storage unit 105 may store a plurality of input histories about the determined input 14 or may store one input history including the plurality of notation data. The input history storage unit 105 is a RAM in which the input history can be stored at a specific position and from which the input history can be read. Instead, the input history storage unit 105 may be a storage circuit or a recording medium that can be random accessed.

The estimation unit 106 estimates a retrieval range from the input position data detected by the detection unit 101 and the input history stored in the input history storage unit 105. The unit 106 notifies the second generation unit 107 of the retrieval range thus estimated. Estimation of a retrieval range using the unit 106 will be explained later in detail. The estimation unit 106 is a circuit or a program installed in a computer, which can estimate retrieval ranges.

The second generation unit 107 retrieves a detailed reference data item identical, in part or entirety, to the notation data included in the first input candidate generated by the first generation unit 102, from the detailed reference data contained in the retrieval range estimated by the estimation unit 106. The second generation unit 107 then generates a second input candidate from the detailed reference data item retrieved. The second input candidate thus generated is input to the presentation unit 108.

The second input candidate includes not only the notation data of the detailed reference data item retrieved, but also the ordinal data item about this detailed reference data item. The second generation unit 107 may impart a score to the second input candidate, depending on the likelihood at which the second input candidate may coincide with the actual input. A plurality of candidates that have the same notation data item and different ordinal data items may be obtained as second input candidates. In this case, the second generation unit 107 combines these candidates together, generating one notation data item and a second input candidate having a plurality of ordinal data items. Generation of the second input candidate using the unit 107 will be explained later in detail. It should be noted here that the second generation unit 107 is either a circuit or a program installed in a computer, which can generate the second input candidate.

The presentation unit 108 generates input candidates 12 from the first input candidates generated by the first generation unit 102 and the second input candidates generated by the second generation unit 107. Some or all of the input candidates generated by the unit 108 are presented to the user 21. Generation of the input candidates 12 using the unit 108 from the first input candidates and second input candidates will be described later. Using the user interface of the apparatus 100, which is shown in FIG. 2, the presentation unit 108 of FIG. 1 presents some or all of the input candidates 12 to the user 21. In the case of FIG. 2, the presentation unit 108 displays as many input candidates 12 as possible, in the input candidate display region 33 of the apparatus 100. Further, the presentation unit 108 notifies the input candidates 12 to the receiving unit 109.

Generation of an input candidate 12 will be explained later. The presentation unit 108 generates an input candidate 12 to present, which is basically a combination of a first input candidate and a second input candidate. If the notation data items about the first and second input candidates are identical, however, the second input candidate has priority over the first input candidate. In this case, the first input candidate is not combined with the second input candidate. Further, the presentation unit 108 may present input candidates 12 in descending order of score. Still further, the presentation unit 108 may normalize the scores of the first and second input candidate in order to evaluate the scores on the same basis. Moreover, the presentation unit 108 may present, as input candidates 12, a prescribed number of first and second input candidates, which have relatively high score. Furthermore, the presentation unit 108 may present only those of the first and second input candidates, which have scores equal to or greater than a preset value.

The receiving unit 109 receives a candidate selection 13 from the user 21 for the input candidate 12 presented by the presentation unit 108. The receiving unit 109 presents, as determined input 14, an input candidate associated with the candidate selection 13 received from the user 21. The determined input 14 is used to update the input history stored in the input history storage unit 105.

Using the user interface of the input assistance apparatus 100 of FIG. 1, which is shown in FIG. 2, the receiving unit 109 receives the candidate selection 13 from the user 21 and presents the determined input 14. In the instance shown in FIG. 2, the receiving unit 109 receives from the user 21 the candidate selection 13 associated with any one of the input candidates 12 presented in the input candidate display region 33. Using the input device 22, the user 21 can select any input candidate he or she wants. On receiving the candidate selection 13, the receiving unit 109 presents the determined input 14 associated with the candidate selection 13, at the input position designated by the cursor 34 displayed in the input position designation/input display region 31.

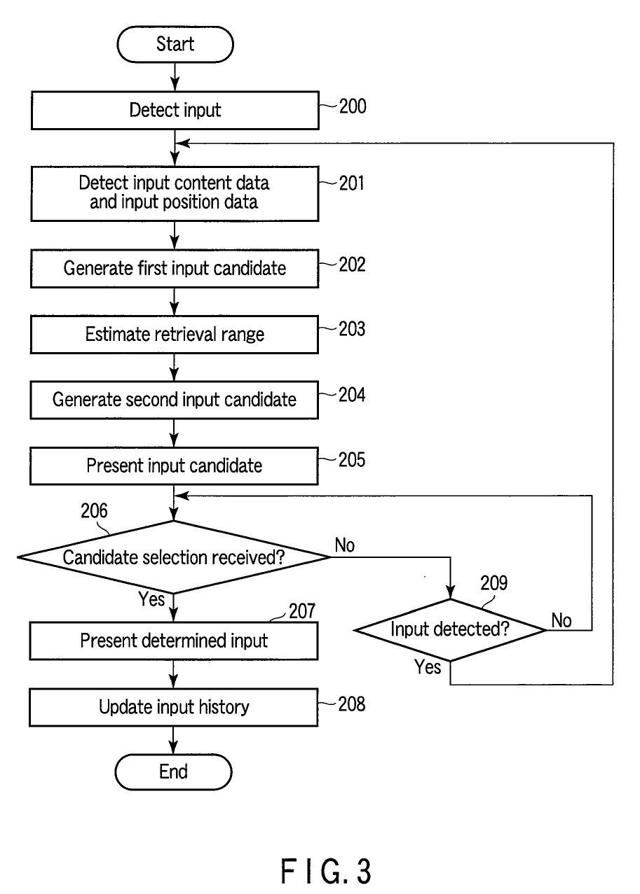

The operating sequence of the input assistance apparatus 100 shown in FIG. 1 will be explained with reference to the flowchart of FIG. 3.

First, the detection unit 101 detects the input 10 that the user 21 has input by referring to the reference data 11 (Step 200). Then, the detection unit 101 detects the input content data and input position data about the input 10 (Step 201). The process goes to Step 202. Note that Step 201 may be performed in the case where the user 21 inputs the input 10 to the detection unit 101, causing the apparatus 100 to present input candidates 12, then inputs additional data without selecting any input candidate 12 he or she has input. The process performed in Step 201 will be explained later in detail.

In Step 202, the first generation unit 102 uses the content data input at present, generating a first input candidate. The first generation unit 102 generates, for example, the notation data and character recognition score that have been acquired by recognizing the characters constituting the input content data. The number of first input candidates the first generation unit 102 is not limited to one. The unit 102 may generate first input candidates the first input candidates which have scores equal to or greater than a preset value.

Next, the estimation unit 106 uses the input position data input at that time and the input history stored in the input history storage unit 105, estimating a retrieval range (Step 203). Note that Steps 202 and 203 may be performed in the inverse order or at the same time. The processes performed in Steps 202 and 203 will be explained later in detail.

Then, in Step 203, the second generation unit 107 retrieves, from the detailed reference data, a detailed reference data item identical, in part or entirety, to the notation data that is contained in the first input candidate generated in Step 202 by the first generation unit 102. In Step 204, the unit 107 generates a second input candidate based on the detailed reference data item retrieved. The process performed in Step 204 will be explained later in detail.

Thereafter, in Step 205, the presentation unit 108 generates an input candidate 12 from the first input candidate generated in Step 202 and the second candidate generated in Step 204. The input candidate 12 thus generated is presented to the user 21. Then, the process goes to Step 206.

In Step 206, the receiving unit 109 waits for a candidate selection 13 that may come from the user 21. On receiving the candidate selection 13 from the user 21, the unit 109 presents to the user 21 the determined input 14 associated with the candidate selection 13 (Step 207). The receiving unit 109 then uses the determined input 14 associated with the candidate selection 13, thereby updating the input history stored in the input history storage unit 105 (Step 208). The process is terminated, and the receiving unit 109 waits for the next input.

Any characters the user 21 has input may be detected in Step 206, though no candidate selections 13 come from the user 21. If this is the case (Step 209), the process returns to Step 201. In Step 201, a process, which will be described later, is performed. Then, the process goes to Step 202.

Estimation of the retrieval range in Step 203 using the estimation unit 106 will be explained in detail.

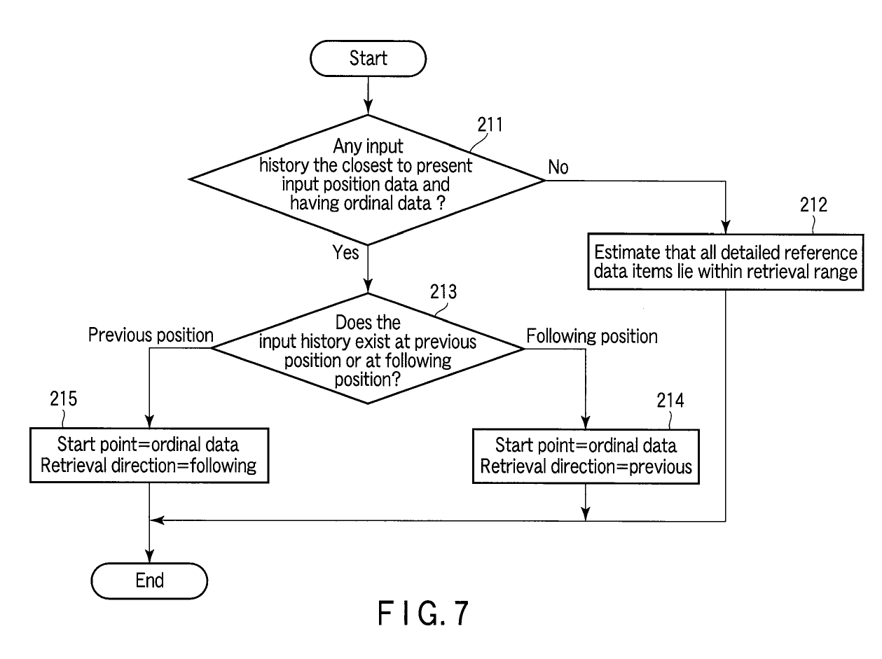

The estimation unit 106 may estimate the retrieval range in such a way as shown in the flowchart of FIG. 7.

First, the estimation unit 106 determines whether an input history exists, which that is the closest to the present input position and has ordinal data (Step 211). As pointed out above, the input history includes the input position data and notation data about the input 14 determined in the past. Further, the input history includes the ordinal data associated with the notation data if the determined input 14 has been selected from the second input candidate. Therefore, if the determined input 14 is one selected from the second input candidate, input history having ordinal data exists. Conversely, if the determined input 14 is not one selected from the second input candidate, there are no input histories having ordinal data. Note that the distance between the input positions may be evaluated from the Euclidean distance between, for example, the coordinates used as input position data. The distance may be evaluated by any other method available.

The estimation unit 106 determines that all detailed reference data items lie within the retrieval range if there is no input history that has ordinal data (Step 212).

If there is an input history that is the closest to the present input position data and has ordinal data, the estimation unit 106 determines whether the input position data represented by the input history exist at previous position or following position (Step 213). As to whether the input position data exist at previous position or following position, it is defined here that the input position data exist at previous position if it is on a row preceding the row of the present input data or on the same row as the row of the present input data, and that it exist following position if it is on a row following the row of the present input data. The preceding and following of the row or column may be determined in accordance with, for example, the language of the input 10.

The input position data of the input history may be found in Step 213 to precede the present input position data. In this case, the estimation unit 106 sets the start point of the retrieval range as the ordinal data represented by the input history retrieved in Step 211 and sets the retrieval direction as “following” (Step 215). On the other hand, input position data of the input history may be found in Step 213 to follow the present input position data. If this is the case, the estimation unit 106 sets the start point of the retrieval range as the ordinal data represented by the input history retrieved in Step 211 and sets the retrieval direction as “previous” (Step 214).

The “start point of the retrieval range” means the ordinal data of certain detailed reference data. The “retrieval direction” means the temporal direction of the detailed reference data to be retrieved. In FIG. 10A, particular ordinal data may be given as the start point of retrieval range and the retrieval direction set may be “following.” Then, those of the detailed reference data items, which have ordinal data items following the ordinal data corresponding to the start point, define the retrieval range, and any detailed reference data items that have the ordinal data preceding the priority corresponding to the start point are excluded from the retrieval range. On the other hand, particular ordinal data may be given as the start point of retrieval range and the retrieval direction set may be “previous.” In this case, those of the detailed reference data items, which have ordinal data items preceding the ordinal data, define the retrieval range, and any detailed reference data items that have the ordinal data following the priority corresponding to the start point are excluded from the retrieval range. Thus, the estimation unit 106 estimates the retrieval range by utilizing the relation between the time position in the reference data 11 and the space position of the input 10.

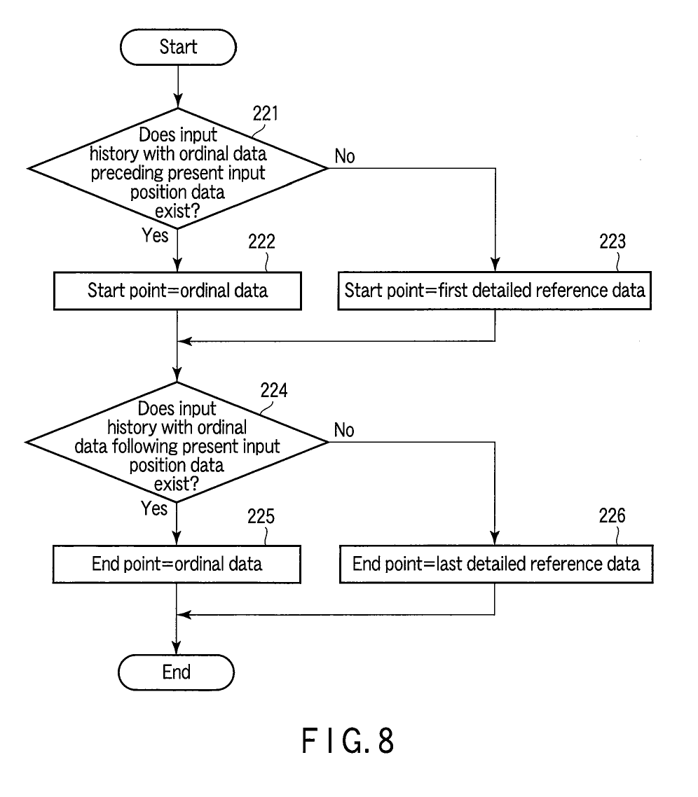

Alternatively, the estimation unit 106 may estimate the retrieval range as is shown in the flowchart of FIG. 8.

First, the estimation unit 106 determines whether an input history exists, which has ordinal data at previous position (Step 221). If input history exists, which has ordinal data at previous position, the estimation unit 106 sets the ordinal data of the input history as the start point of the retrieval range (Step 222). If a plurality of ordinal data items exist, the estimation unit 106 may sets a plurality of start points over the retrieval range. On the other hand, if no input history exists, which has ordinal data at previous position, the estimation unit 106 sets the first ordinal data of the detailed reference data as the start point of the retrieval range (Step 223).

In Step 224, the estimation unit 106 searches for any input history that has ordinal data at following position. An input history having ordinal data may exist at following position. In this case, the estimation unit 106 sets the ordinal data of the input history as the end point of the retrieval range (Step 225). If a plurality of ordinal data items exist, a plurality of end points may be set over the retrieval range. On the other hand, no input history having ordinal data may exist at following position. In this case, the estimation unit 106 sets the ordinal data of the detailed reference data as the end point of the retrieval range (Step 226).

In the instance of FIG. 8, the start point and end point of the retrieval range are ordinal data items of the detailed reference data and define the retrieval range. That is, the retrieval range is detailed reference data that has ordinal data items following the ordinal data item representing the start point and preceding the ordinal data representing the end point. A plurality of start points and a plurality of end points may exist as shown in FIG. 10B. If so, a plurality of retrieval range candidates are exist. Which retrieval candidate is actually used is determined by the second generation unit 107 as will be explained later.

The process of the estimation unit 106 performs to estimate the retrieval range is not limited to those explained with reference to the flowcharts of FIGS. 7 and 8. Rather, the unit 106 may perform an appropriate combination of the processes shown in FIGS. 7 and 8.

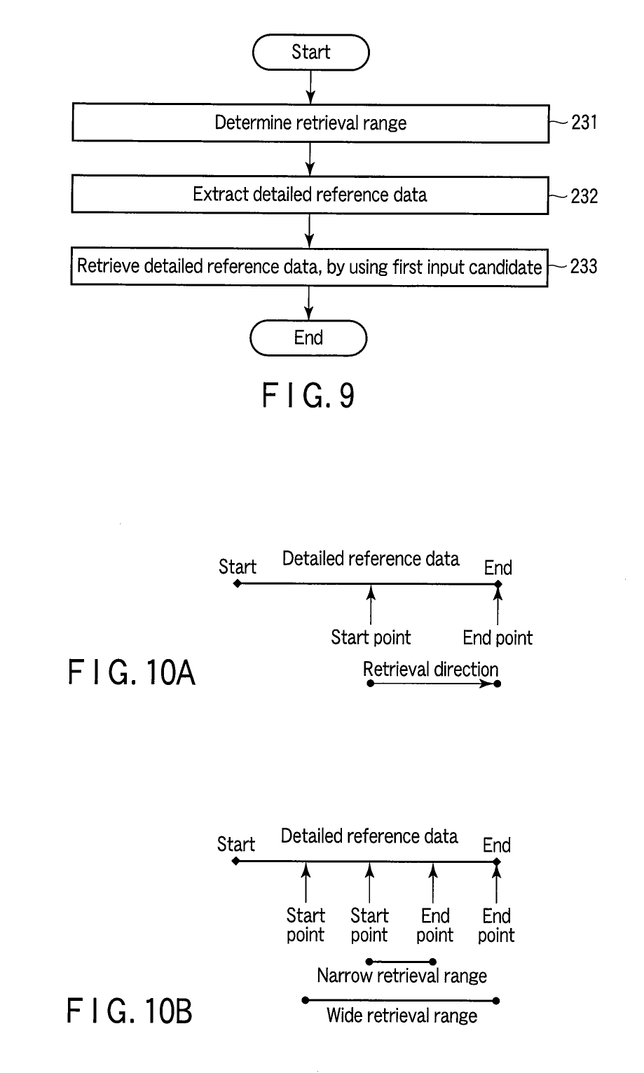

Generation of the second input candidate in Step 204 using the second generation unit 107 will be explained in detail with reference to FIG. 9.

First, the second generation unit 107 determines an actual retrieval range from the retrieval range the estimation unit 106 has estimated in Step 203 (Step 231). As described above, the estimation unit 106 may estimate a plurality of retrieval ranges. In such a case, the second generation unit 107 may selects the narrowest retrieval range as shown in the upper part of FIG. 10B, or the broadest retrieval range as shown in the lower part of FIG. 10B. Alternatively, the unit 107 may select the actual retrieval range in accordance with any other evaluation basis. Which method the unit 107 performs to select the actual retrieval range is determined in accordance with the objective for which the input assistance apparatus is used.

Next, the second generation unit 107 extracts, from the detailed reference data storage unit 104, the detailed reference data having the ordinal data that is included in the reference range set in Step 231 (Step 232).

Then, the second generation unit 107 retrieves, from the detailed reference data extracted in Step 232, the detailed reference data having the notation data identical, either in part or entirety, to the notation data of the first input candidate that the first generation unit 102 has generated in Step 202 (Step 233). More precisely, the second generation unit 107 may perform prefix search using the notation data of the first input candidate, or may confirm whether the notation data of any component of each detailed reference data item is identical to the notation data of the first input candidate. The second generation unit 107 generates the second input candidate from the detailed reference data retrieved in Step 233.

The second generation unit 107 can thus perform an efficient retrieval by using the retrieval range the estimation unit 106 has estimated. Further, the second generation unit 107 may retrieve all detailed reference data items in Step 232, and the retrieval range estimated may be used to correct the score. In other words, the unit 107 may add or subtract a prescribed value to or from the score of the second input candidate obtained from the estimated retrieval range, thereby minimizing missed input candidates and thus increasing the accuracy of input prediction.

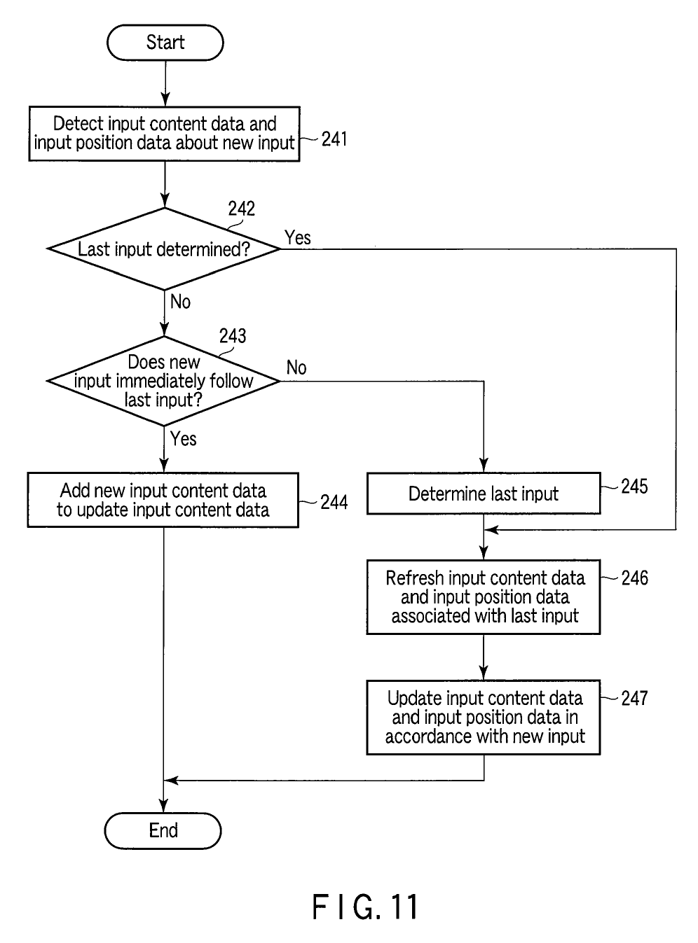

In connection with the detection (Step 201) of the input content data and input position data about the input 10, the user 21 may made an additional input without selecting any input candidate that the input assistance apparatus has presents for the input the user 21 has made immediately before. The sequence of the process performed in this case will be explained in detail with reference to the flowchart of FIG. 11.

First, the detection unit 101 detects the input content data and input position data about the new input (Step 241). Then, it is determined whether the last input has been determined (Step 242). If the last input has been determined, the detection unit 101 initializes the input content data and input position data about the last input (Step 246). Note that the last input is regarded as determined, if determined input has been made immediately before or if no input has been made at all. The detection unit 101 then updates the input content data and input position data by using the new input detected in Step 241 (Step 247). Thus, the process terminates.

If the last input has not been determined (Step 242) and if the new input immediately follows the last input (in Step 243), the detection unit 101 adds the input content data about the last input, which has been detected in Step 241, to the new input, thereby updating the input content data (Step 244). The process is terminated. Whether the new input is an additional one is determined in accordance with the position where the last input is made and with the position where the new input is made. For example, the new input is regarded as an additional one if the positional difference between the two inputs falls within a predetermined range and if the new input exists at the following position. Note that inputs made continuously may be data items each representing one character as in the example described later, or may be data items each representing one stroke of a character. Which kind of data is used as an input unit may be determined in accordance with an objective for which the input assistance apparatus is used.

If the last input has not been determined (Step 242) and if the new input immediately does not follow the last input (Step 243), the detection unit 101 determines the last input (Step 245) and initializes the input content data and input position data about the last input (Step 245). The detection unit 101 then updates the input content and position of the new input detected in Step 241 as input content data and input position data, respectively (Step 247). Thus, the process terminates. To set the last input in Step 245, the detection unit 101 may perform a process equivalent to the combination of Steps 207 and 208, using, for example, the candidate 12 having the greater score than any other candidate presented, as the determined input 14. For the same purpose, the detection unit 101 may alternatively neglects the last input, simply discarding the input content data and input position data about the last input. If the input content data and input position data about the last input are discarded, the determined input 14 corresponds to no inputs.

Operation of the input assistance apparatus 100 of FIG. 1 will be explained with reference to the flowchart of FIG. 3.

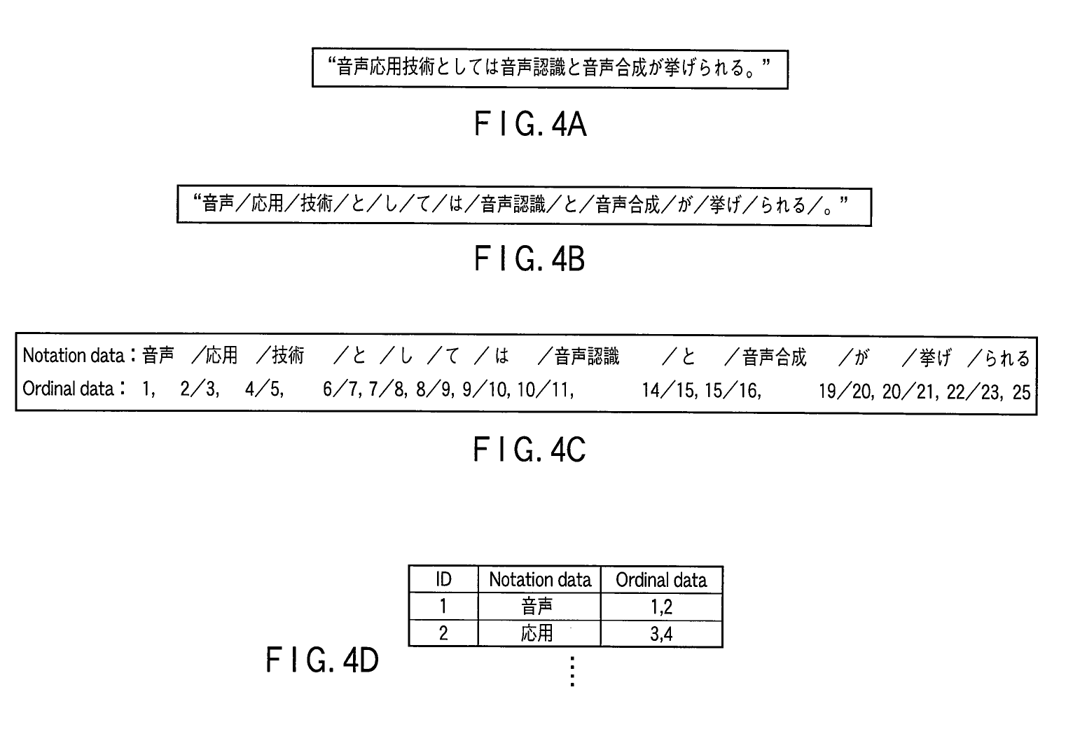

First, the conditions under which the apparatus 100 is used will be described. The reference data 11 is a text “ [symbol] [symbol] [symbol] ” shown in FIG. 4A. The detailed reference data extraction unit 103 analyzes, for example, the morphemes of the words constituting the reference data 11 shown in FIG. 4A. Then, the unit 103 splits the reference data 11 into words as illustrated in FIG. 4B. The morphologic analysis may result in a plurality of candidates for one word (for example, “ [symbol] ” and “ [symbol] [symbol] ”). In this case, the detailed reference data extraction unit 103 may use one of the candidates or all the candidates. Next, the detailed reference data extraction unit 103 extracts the notations of the words determined by the morphologic analysis and shown in FIG. 4C, as notation data items. The unit 103 then extracts ordinal data items about the words (FIG. 4B) split through the morphologic analysis, each ordinal data item representing the ordinal numbers that indicates the positions that the characters constituting each word assumes in the reference data 11 as illustrated in FIG. 4C. For example, the first word “ [symbol] ” of the reference data 11 is represented by ordinal data (1, 2), where “1” and “2” represent “ [symbol] ” and “ [symbol] ,” i.e., the first and second characters of the reference data 11, respectively. The detailed ordinal data (FIG. 4C) extracted by the unit 103 is supplied to the detailed reference data storage unit 104 and stored therein in such a manner as shown in FIG. 4D. As seen from FIG. 4D, the identification number (ID) of the notation data item about each word is associated with the ordinal data item of detailed reference data item about the word, but is not absolutely necessary. Nonetheless, ID is used, to facilitate the description of each embodiment of the invention.

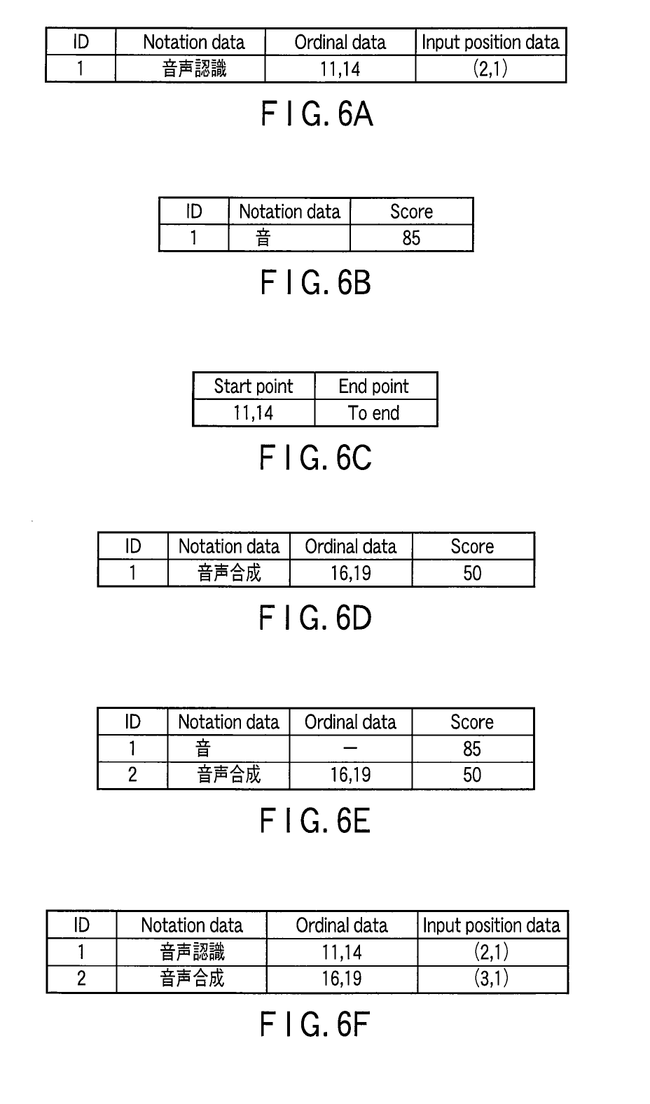

Assume that in the present embodiment, the input history storage unit 105 stores the input history shown in FIG. 6A. Also assume that the input position data is designated by a row and column in the input position designation/input display region 31 and may be processed in terms of row and column. Further assume that the input position designation/input display region 31 displays the determined input 14 that corresponds to the input history of FIG. 6A.

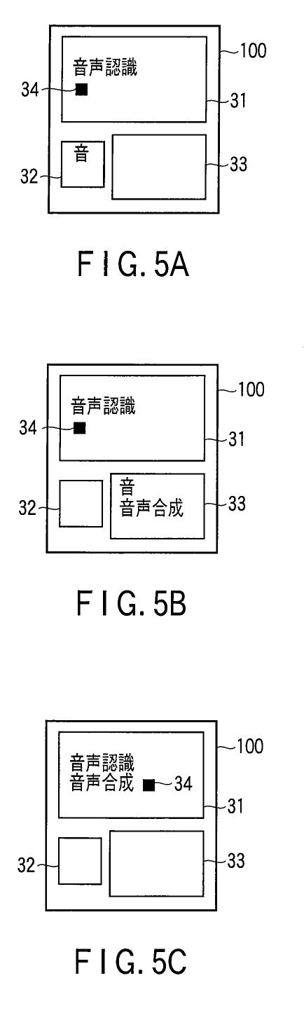

Under the conditions specified above, the user 21 may use the input device 22, generating an input 10, or character “ [symbol] ” in the character input region 32 as shown in FIG. 5A. Assume that at this point, the cursor 34 points to the intersection of the third row and the first column, i.e., input position data (3, 1).

The detection unit 101 detects the input content data and input position data (3, 1) about the input 10 (Step 201, more precisely, the sequence of Steps 241, 242, 246 and 247). The input content data is data that can be used in the existing character recognition, such as image data or stroke data about character “ [symbol] ” that the user 21 has input.

The first generation unit 102 performs character recognition on the input content data detected in Step 201, as is illustrated in FIG. 6B. The unit 102 thus generates notation data “ [symbol] ” and a character recognition score “85” (Step 202). The notation data and the score “85” will be used as first input candidate.

The estimation unit 106 estimates a retrieval range from the input position data (3, 1) detected in Step 201 and the input history shown in FIG. 6A (Step 203). Note that the estimation unit 106 estimates a retrieval range as has been explained with reference to the flowchart of FIG. 8.

The input history having ordinal data representing a position preceding the present input position data (3, 1) is input history having ID=1 (see FIG. 6A). No input history exists, which has ordinal data representing a position following the present input position data (3, 1). Hence, the estimation unit 106 estimates the retrieval range that starts at point (11, 14) and ends at the end point of detailed reference data (i.e., twenty fifth character) as is illustrated in FIG. 6C.

The second generation unit 107 searches the detailed reference data over the retrieval range shown in FIG. 6C, for detailed reference data items that have notation data items identical, partly or entirely, to the notation data “ [symbol] ”. From the detailed reference data items thus found, the second generation unit 107 generates the second input candidate shown in FIG. 6D (Step 204). More specifically, the second generation unit 107 performs prefix search, using the notation data of the detailed reference data for the fifteenth to twenty fifth characters, in order to find the notation data “ [symbol] ” for the first input candidate. Although no detailed reference data equivalent to the start point (11, 14) exists in the retrieval range, such detailed reference data may exist in the retrieval range.

The presentation unit 108 generates the input candidate 12 from shown in FIG. 6E (Step 205). The input candidate 12 has been generated from the first input candidate shown in the FIG. 6B and the second input candidate shown in FIG. 6D. More precisely, the presentation unit 108 displays as many input candidates 12 (FIG. 6E) as possible in the input candidate display region 33, in ascending order of score, as is illustrated in FIG. 5B.

The receiving unit 109 receives from the user 21 the candidate selection 13 associated with the input candidate having ID=2 and shown in FIG. 6E (Step 206). As shown in FIG. 5C, the unit 109 displays the determined input 14 associated with the candidate selection 13, in the input position designation/input display region 31, thereby presenting the determined input 14 to the user 21 (Step 207). Using the determined input 14 associated with the candidate selection 13 received in Step 206, the receiving unit 109 updates the input history shown in FIG. 6A (Step 208). The process is terminated.

As has been described, the input assistance apparatus according to this embodiment narrows down the retrieval range from which to generate the second input candidate, on the basis of the relation between the time position data contained in the reference data and the space position data contained in the user input that refers to the reference data. The input assistance apparatus according to this embodiment can therefore generate the second input candidate from the reference data at high efficiency.

With the embodiment described above, the user 21 may make an input, not at the input position (3, 1) but, for example, input position (1, 1) that precedes input position (2, 1). In this case, the notation data of the detailed reference data preceding the start point (11, 14) is retrieved, and the second candidate is generated from the notation data thus retrieved, i.e., “ [symbol] ”.

### Second Embodiment

An input assistance apparatus according to a second embodiment of this invention is identical in configuration to the assistance apparatus 100 according to the first embodiment, but performs a different process when the user makes an additional input. Therefore, the different process will be described in the main.

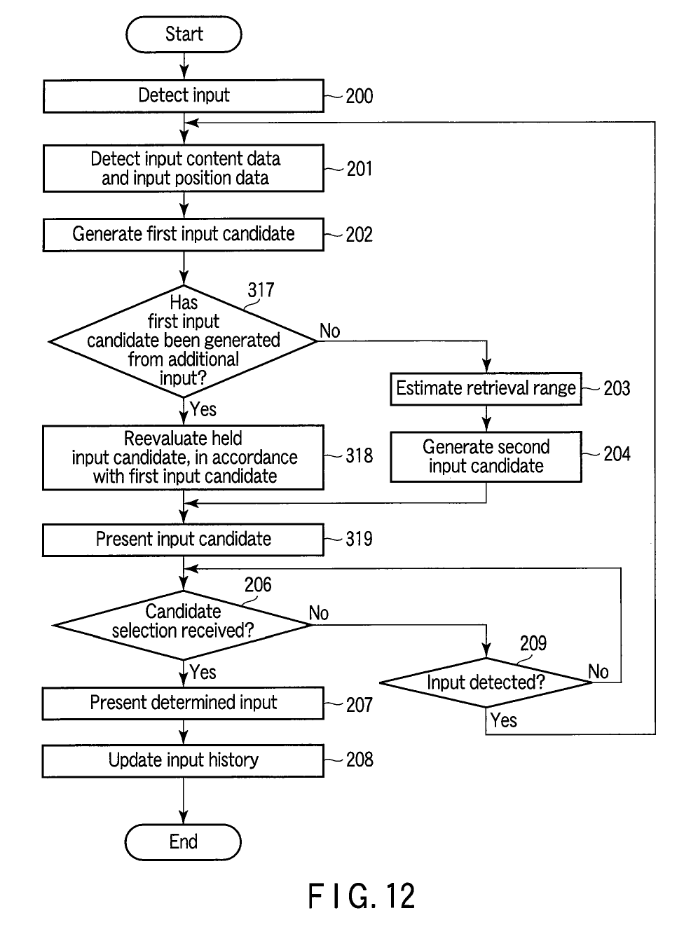

Operation of the input assistance apparatus according to this embodiment will be explained with reference to the flowchart of FIG. 12. The steps identical to those shown in FIG. 3 are designated by the same reference numerals and will not be described.

Assume that the presentation unit 108 keeps holding the input candidate generated last, until a new input candidate to present is generated.

The process performed in Step 201, i.e., process of detecting the input content data and input position data about a new input, in order to determine whether the new input made by the user 21 is an additional one or not, is exactly the same as explained with reference to FIG. 11. In the next step, i.e., Step 202, the first generation unit 102 generates a first input candidate form the input content data detected. If the first input candidate has not been generated in Step 202 from the additional input (Step 317), Step 203 (i.e., the step of estimating the retrieval range) and the steps following Step 203 will be performed as in the first embodiment. The input candidate 12 is generated from the first and second input candidates and is presented to the user 21 in the same way as in the first embodiment (Step 319).

If the first input candidate has been generated from the additional input (Step 317), the presentation unit 108 reevaluates the input candidate 12 that it has been holding, based on the first input candidate (Step 318). To “reevaluate the input candidate 12” is to determine to what extent the input candidate 12 is similar to the first input candidate. For example, the presentation unit 108 uses the notation data of the first input candidate, performing the prefix matching or the existing DP matching. The presentation unit 108 can therefore update the score of the input candidate 12 or can selects, as new input candidate to present, the input candidate 12 more similar to the first input candidate than any other input candidate 12. Then, the presentation unit 108 presents to the user 21 the new input candidate generated in Step 318, i.e., the reevaluation of the input candidate 12 (Step 319). Thus, the step of estimating the retrieval range (Step 203) and the step of generating the second candidate (Step 204) can be skipped if the input immediately follows the last input.

Operation of the input assistance apparatus according to this embodiment will be explained with reference to the flowchart of FIG. 12. Assume that the conditions under which the apparatus operates are identical to those in which the apparatus according to the first embodiment operates. Also assume that there is no input history.

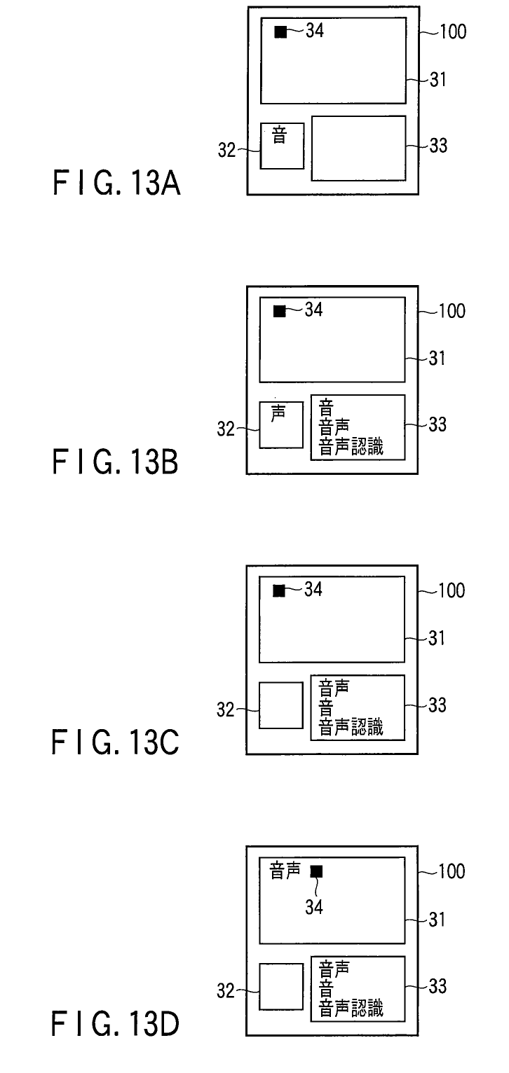

Under such conditions, the user 21 may use the input device 22, generating an input 10, or character “ [symbol] ” in the character input region 32 as shown in FIG. 13A. Assume that at this point, the cursor 34 points to the input position data (1, 1).

The detection unit 101 detects the input content data and input position data (1, 1) about the input 10 (Step 201). The input content data is data that can be used in the existing character recognition, such as image data or stroke data about character “ [symbol] ” that the user 21 has input.

The first generation unit 102 performs character recognition on the input content data detected in Step 201 (more precisely, the sequence of Steps 241, 242, 246 and 247). The unit 102 thus generates notation data “ [symbol] ” and a character recognition score “85” (Step 202). The notation data and the score “85” will be used as first input candidate.

The estimation unit 106 estimates a retrieval range from the input position data (1, 1) detected in Step 201 and input history, if any in the input history storage unit 105 (Step 203). Since no input history exists as described above, the estimation unit 106 estimates, as retrieval range, the entire detailed reference data.

The second generation unit 107 searches the detailed reference data over the retrieval range estimated in Step 203, for detailed reference data items that have notation data items identical, partly or entirely, to the notation data “ [symbol] ”. From the detailed reference data items thus found, the second generation unit 107 generates the second input candidate (Step 204).

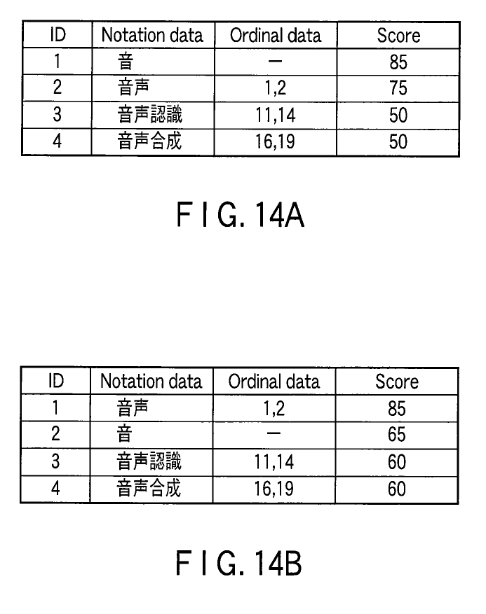

The presentation unit 108 generates input candidate 12 (FIG. 14A) to present, from the first input candidate generated in Step 202 and second input candidate generated in Step 204. The presentation unit 108 displays as many input candidates 12 as possible in the input candidate display region 33, in ascending order of score (Step 319).

The receiving unit 109 waits for a candidate selection 13 that may come from the user 21 (Step 206). Assume that the user 21 uses the input device 22, generating an additional input, e.g., character “ [symbol] ” to write in the character input region 32, as illustrated in FIG. 13B. If this additional input is detected (Step 209), the detection unit 101 detects the input content data and input position data (1, 1) about the new input (Step 201, more precisely Step 242).

Since the last input has not been determined (Step 242) and the new input is an additional one immediately following the last input (Step 243), the detection unit 101 adds the input content data of the input detected in Step 241 to the input content data about the last input, updating the input content data (Step 244). Then, the first generation unit 102 performs character recognition on the input content data updated in Step 314, generating notation data “ [symbol] ” and a character recognition score, both as the first input candidate (Step 202). The first input candidate is a candidate for the additional input continuous to the immediately preceding input (Step 317). Therefore, the presentation unit 108 uses the notation data “ [symbol] ” contained in the first input candidate generated in Step 202, reevaluating the input candidate generated in Step 319 (Step 318). To “reevaluate the input candidate” is to perform the existing DP matching on the notation data items, determining the distance between these data items, and then to recalculate the score from the distance. As a result, the presentation unit 108 generates such input candidates as shown in FIG. 14B.

Then, the presentation unit 108 presents to the user 21 the new input candidate generated in Step 318, i.e., the reevaluation of the input candidate 12 (Step 205). More specifically, the presentation unit 108 displays as many input candidates 12 as possible in the input candidate display region 33 as shown in FIG. 13C, in ascending order of score, thus presenting the input candidates 12 to the user 21.

The receiving unit 109 receives from the user 21 the candidate selection 13 associated with the input candidate having ID=1 and shown in FIG. 14B (Step 206). As shown in FIG. 13D, the unit 109 displays the determined input 14 associated with the candidate selection 13, in the input position designation/input display region 31, thereby presenting the determined input 14 to the user 21 (Step 207). Using the determined input 14 associated with the candidate selection 13 received in Step 206, the receiving unit 109 updates the input history (Step 208). The process is terminated.

As has been described, the input assistance apparatus according to this embodiment acquires the first input candidate from the input content data updated with an additional input if the additional input is continuous to the input immediately preceding it. The apparatus then reevaluates the input candidate it holds, which renders it unnecessary to estimate the retrieval range or to generate the second input candidate. Hence, in the input assistance apparatus according to this embodiment, a redundant process need not be performed when an additional input is made, immediately following the last input.

### Third Embodiment

An input assistance apparatus according to a third embodiment of this invention is identical in configuration to the assistance apparatus 100 according to the first embodiment, but is different in part of the operation. Further, this apparatus has a first generation unit 112, a detailed reference data extraction unit 113, an input history storage unit 115, a second generation unit 117, and an presentation unit 118, in place of the first generation unit 102, detailed reference data extraction unit 103, input history storage unit 105, second generation unit 107 and presentation unit 108, respectively. Therefore, the components that characterize this apparatus will be described in the main.

The first generation unit 112 acquires an input 10 from the input content data detected by the detection unit 101. To be more specific, the unit 112 performs character recognition on the input content data about the input 10, acquiring notation data in the same way as the first generation unit 102 does, and then acquires pronunciation data that corresponds to the notation data. The first generation unit 112 can generate the pronunciation data from the notation data, by using, for example, a dictionary or a rule in which notation data items are associated with pronunciation data items. The first input candidate has notation data and pronunciation data. As in the first embodiment, a plurality of first input candidates may exist. Therefore, each first input candidate is composed of any appropriate combination of a notation data item and a pronunciation data item. The first generation unit 112 inputs a first input candidate to the second generation unit 117 and presentation unit 118.

The detailed reference data extraction unit 113 extracts detailed reference data from reference data. The detailed reference data extracted contains at least ordinal data, notation data and pronunciation data.

The input history storage unit 115 stores an input history. The input history includes at least the input position data about any input 14 determined in the past and the notation of the input 14. The input history may include the pronunciation data, too. If the determined input 14 has been selected from the second input candidate (described later), the input history includes the ordinal data representing the order of notation data items. Further, the input history includes the ordinal data associated with the notation data if the determined input 14 has been selected from the second input candidate.

The second generation unit 117 searches the detailed reference data over the retrieval range estimated by the estimation unit 106, for detailed reference data items that have notation data items identical, partly or entirely, to the pronunciation data contained in the first input candidate generated by the first generation unit 112. From the detailed reference data items thus found, the unit 117 generates a second input candidate. The second input candidate thus generated is input to the presentation unit 118. Assume that the second input candidate contains the ordinal data about the detailed reference data retrieved, as well as the notation data and the pronunciation data.

The second generation unit 117 may use not only the pronunciation data, but also the notation data, in order to retrieve detailed reference data. For example, the second generation unit 117 may retrieve detailed reference data that is identical to the first input candidate in terms of both the pronunciation data and the notation data. As in the first embodiment, the second input candidate may be combined to contain identical notation data items if there are a plurality of candidates. In other words, the second input candidate may contain a plurality of ordinal data items. As in a Chinese character, one notation data may be associated with a plurality of pronunciation data items. In such a case, the second generation unit 117 may cause the pronunciation data item of the largest score to represent all pronunciation data items. Alternatively, the unit 117 may associate the pronunciation data items with a common notation data item, generating a plurality of second input candidates.

The operating sequence of the input assistance apparatus according to this embodiment is similar to that of the first embodiment, but different in part of the flowchart shown in FIG. 3 as will be described below.

In Step 202, the first generation unit 112 generates, as first input candidate, the notation data acquired by performing character recognition on the input content data, the pronunciation data associated with the notation data and the character recognition score.

In Step 204, the second generation unit 117 retrieves, from the detailed reference data over the retrieval range estimated in Step 203, the detailed reference data having the pronunciation data identical, either in part or entirety, to the pronunciation data contained in the first input candidate generated in Step 202, and then generates second input candidate from the detailed reference data thus retrieved.

In Step 205, the presentation unit 118 can generate an input candidate 12 in the same way as in the first and second embodiments. In generating the input candidate 12, the unit 118 can combine not only input candidates identical in terms of notation data, but also input candidates identical in terms of pronunciation data.

Operation of the input assistance apparatus according to this embodiment will be explained.

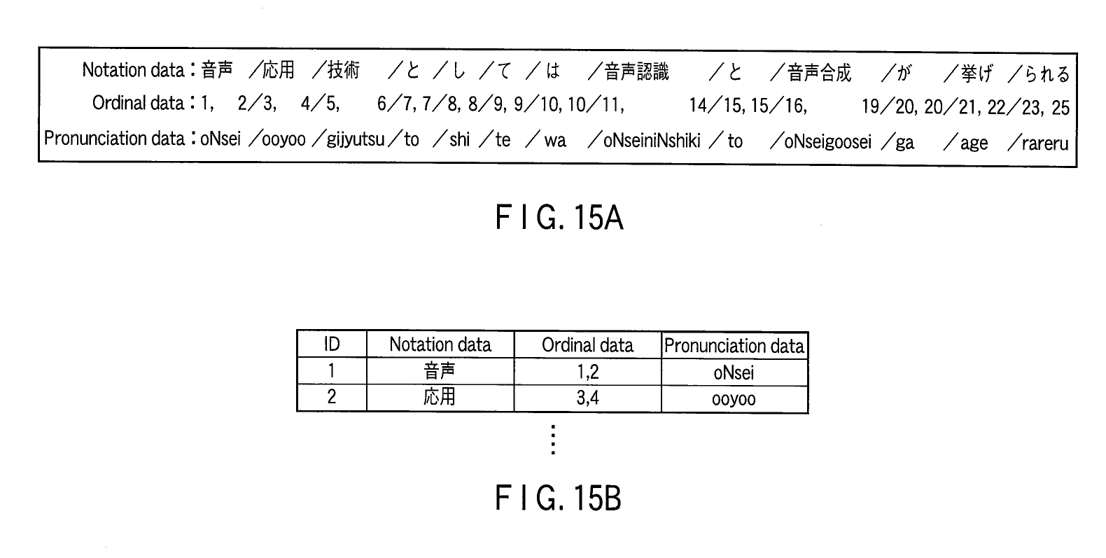

First, the condition under which this apparatus 100 is used will be described. The reference data 11 is a text “ [symbol] [symbol] [symbol] ” shown in FIG. 4A. Under this condition, the detailed reference data extraction unit 113 analyzes, for example, the morphemes of the words constituting the reference data 11 shown in FIG. 4A. Then, the unit 103 splits the reference data 11 into words as illustrated in FIG. 4B. The morphologic analysis may result in a plurality of candidates for one word. The detailed reference data extraction unit 113 then extracts, as notation data, the notation of each word (FIG. 4B), as is illustrated in FIG. 15A. Further, the unit 113 extracts the ordinal data about each word (FIG. 4B) identified by the morphologic analysis, as the ordinal data about the word. The ordinal data represents the ordinal numbers of the first and last characters of the word, as seen from FIG. 15A. Moreover, the detailed reference data extraction unit 113 extracts the pronunciation data associated with the notation data. Note that the pronunciation data is composed of phonemes as shown in, for example, FIG. 15A. The detailed reference data (FIG. 15A) extracted by the unit 113 is stored in the detailed reference data storage unit 104 as illustrated in FIG. 15B.

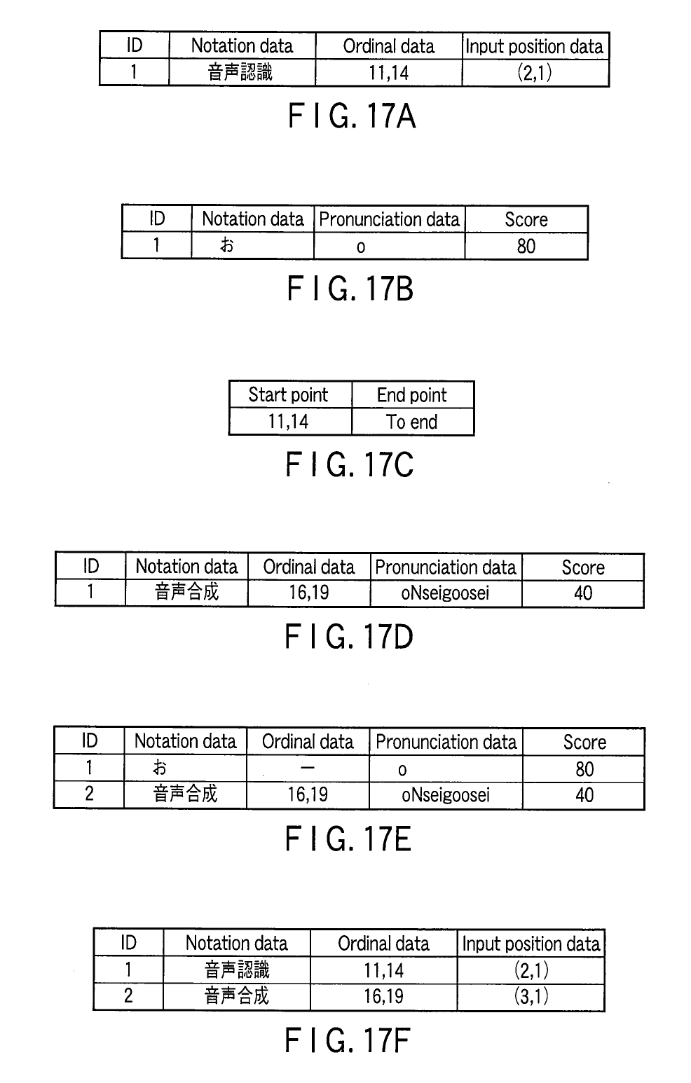

Assume that in this embodiment, the input history storage unit 115 stores the input history shown in FIG. 17A. Also assume that the input position designation/input display region 31 displays the determined input 14 that corresponds to the input history of FIG. 17A.

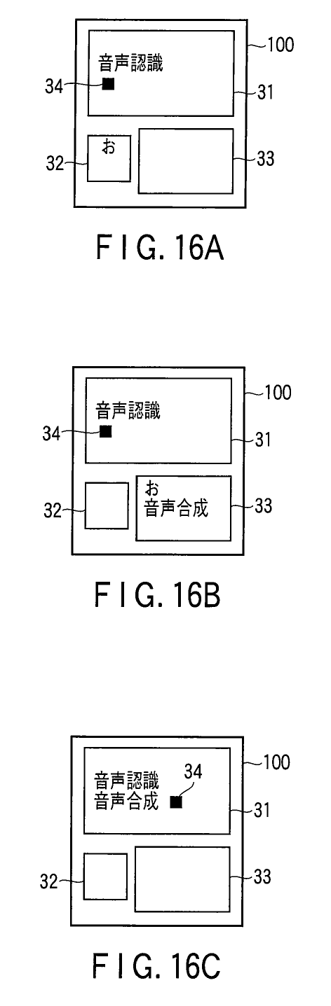

Under the conditions specified above, the user 21 may use the input device 22, generating an input 10, or character “ [symbol] ” in the character input region 32 as shown in FIG. 16A. Assume that at this point, the cursor 34 points to the intersection of the third row and the first column, i.e., input position data (3, 1).

The detection unit 101 detects first the input 10 (Step 200) and then the input content data and input position data (3, 1) about the input 10 (Step 201). The input content data is data that can be used in the existing character recognition, such as image data or stroke data about character “ [symbol] ” that the user 21 has input.

The first generation unit 112 performs character recognition on the input content data detected in Step 201, as is illustrated in FIG. 17B. The unit 102 thus generates notation data “ [symbol] ” and the character recognition score “85” and pronunciation data “o”, both associated with the notation data “ [symbol] ”, as first input candidate (Step 202).

The estimation unit 106 estimates a retrieval range from the input position data (3, 1) detected in Step 201 and the input history shown in FIG. 17A (Step 203). Note that the estimation unit 106 estimates a retrieval range as has been explained with reference to the flowchart of FIG. 8.

The input history having ordinal data representing a position preceding the present input position data (3, 1) is input history having ID=1 (see FIG. 17A). No input history exists, which has ordinal data representing a position following the present input position data (3, 1). Hence, the estimation unit 106 estimates the retrieval range that starts at point (11, 14) and ends at the end point of detailed reference data (i.e., twenty fifth character) as is illustrated in FIG. 17C.

The second generation unit 117 searches the detailed reference data over the retrieval range shown in FIG. 17C, for detailed reference data items that have pronunciation data items identical, partly or entirely, to the pronunciation data “o”. From the detailed reference data items thus found, the second generation unit 117 generates the second input candidate shown in FIG. 17D (Step 204). More specifically, the second generation unit 117 performs prefix search, using the pronunciation data “o” of the detailed reference data for the fifteenth to twenty fifth characters. Although no detailed reference data equivalent to the start point (11, 14) exists in the retrieval range, such detailed reference data may exist in the retrieval range.

The presentation unit 118 generates the first input candidate shown in FIG. 17B and presents the input candidate 12 shown in FIG. 17E from the first and second input candidates shown in FIGS. 17B and 17D, respectively (Step 205). More precisely, the presentation unit 108 displays as many input candidates 12 (FIG. 17E) as possible in the input candidate display region 33, in ascending order of score, as is illustrated in FIG. 16B.

The receiving unit 109 receives from the user 21 the candidate selection 13 associated with the input candidate having ID=2 shown in FIG. 17E (Step 206). As shown in FIG. 16C, the unit 109 displays the determined input 14 associated with the candidate selection 13, in the input position designation/input display region 31, thereby presenting the determined input 14 to the user 21 (Step 207). Using the determined input 14 associated with the candidate selection 13 received in Step 206, the receiving unit 109 updates the input history shown in FIG. 17A (Step 208). The process is terminated.

As has been described, the input assistance apparatus according to this embodiment retrieves and generates the second input candidate, by using pronunciation data, not notation data as in the first embodiment. Therefore, this input assistance apparatus can generate the second input candidate even if the user input differs from the detailed reference data in terms of notation data. To be more specific, the apparatus according to this embodiment can accomplish input assistance, even if the user does not know the correct notation data of reference data because this reference data is speech data. Moreover, this input assistance apparatus can generate a Chinese character input candidate, even if the user has input Hiragana characters, instead of a Chinese character.

### Fourth Embodiment

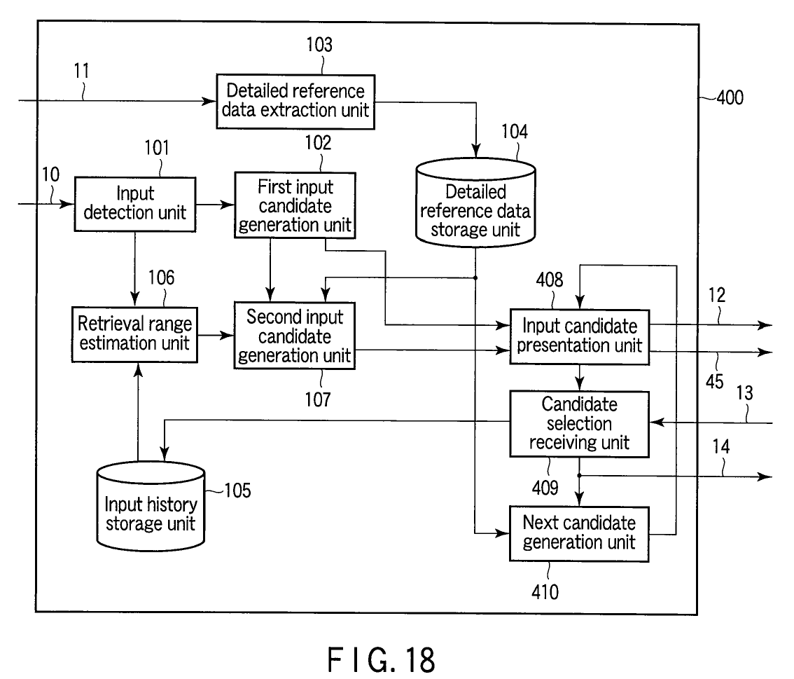

As shown in FIG. 18, an input assistance apparatus 400 according to a fourth embodiment of this invention is similar to the apparatus 100 shown in FIG. 1. The apparatus 400 differs from the apparatus 100 in two respects. First, it has an presentation unit 408 and a receiving unit 409 in place of the presentation unit 108 and receiving unit 109, respectively. Second, it has a third generation unit 410. In FIG. 18, the components identical to those shown in FIG. 1 are designated by the same reference numerals. The components characterizing the apparatus 400 will be described in the main.

Like the presentation unit 108, the presentation unit 408 generates an input candidate 12 from the first and second input candidates generated by the first and second generation unit 102 and 107, respectively. The input candidate 12 thus generated is presented to the user 21. On receiving a next input candidate 45 from the third generation unit 410, which will be described later, the presentation unit 408 presents the next input candidate 45 to the user 21. The unit 408 uses, for example, a user interface of the type shown in FIG. 2, presenting the input candidate 12 and the next input candidate 45 to the user 21. In the instance of FIG. 2, the presentation unit 408 displays the input candidate 12 and next input candidate 45 to the user 21 in the input candidate display region 33. The input candidate 12 and the next input candidate 45 may be presented at the same time, or one may be presented preferentially over the other. Further, the presentation unit 408 may notify the input candidate 12 and next input candidate 45 to the receiving unit 409.

The receiving unit 409 receives a candidate selection 13 coming from the user 21, with respect to the input candidate 12 and next input candidate 45 presented by the presentation unit 408. The receiving unit 409 presents the input candidate associated with the candidate selection 13 received from the user 21, to the user 21 as determined input 14. Using the determined input 14, the receiving unit 409 updates the input history stored in the input history storage unit 105. Further, the unit 409 notifies the determined input 14 to the third generation unit 410.

Using a user interface of the type shown in FIG. 2, the receiving unit 409 receives the candidate selection 13 from the user 21 and then presents the determined input 14. In the instance of FIG. 2, the unit 409 receives from the user 21 the candidate 13 selected for the input candidate 12 or the next input candidate 45, either displayed in the input candidate display region 33. Using the input device 22, the user 21 selects an appropriate input candidate from those presented. On receiving the determined input 14 associated with the candidate selection 13, the receiving unit 409 displays the determined input 14 associated with the candidate selection 13, at the input position designated by the cursor 34 in the input position designation/input display region 31.

The determined input 14 that is supplied from the receiving unit 409 may contain ordinal data. In this case, the third generation unit 410 generates next input candidate 45 from the ordinal data. The next input candidate 45 is input to the presentation unit 408. More precisely, the third generation unit 410 acquires, from the detailed reference data storage unit 104, the detailed reference data that has the ordinal data following the ordinal data the determined input 14. The unit 410 then generates next input candidate 45 having the notation data and ordinal data of the detailed reference data.

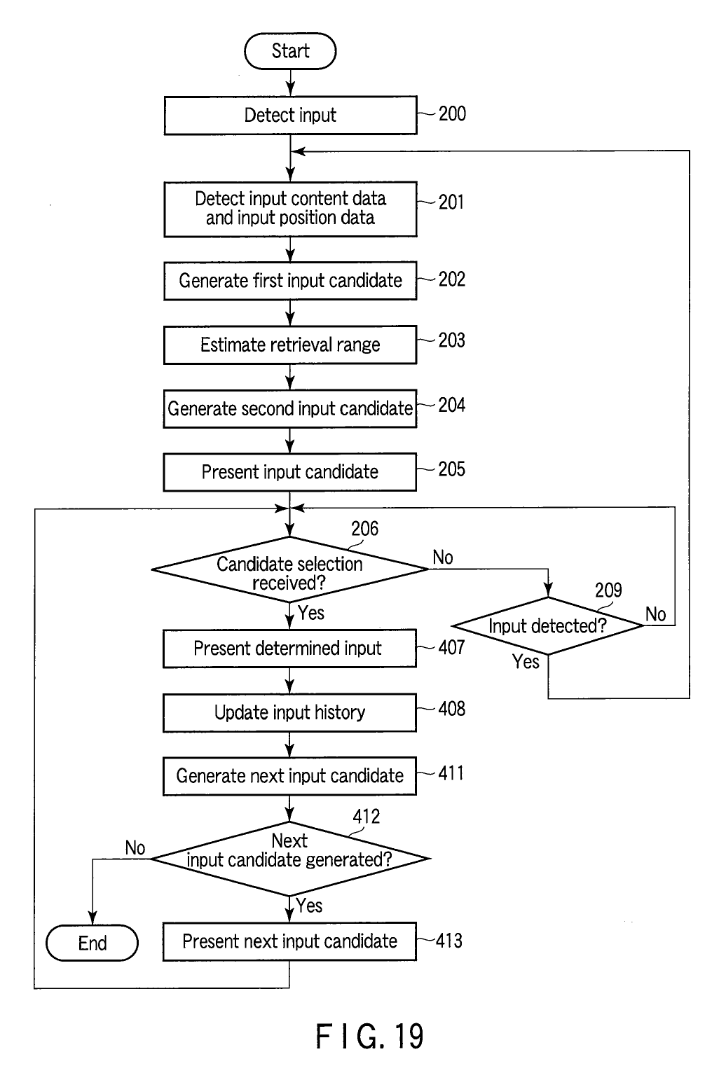

The operating sequence of the input assistance apparatus 400 shown in FIG. 18 will be explained with reference to the flowchart of FIG. 19. In FIG. 19, the steps identical to those shown in FIG. 3 are designated by the same reference numerals. The steps different from those shown in FIG. 3 will be described in the main.

In Step 206, whether the receiving unit 409 has received a candidate selection 13 from the user 21 is determined. If the receiving unit 409 has received a candidate selection 13 from the user 21, the process goes to Step 407. In Step 407, the receiving unit 409 presents to the user 21 the determined input 14 associated with the candidate selection 13. Using the determined input 14 associated with the candidate selection 13 received, the receiving unit 409 updates the input history stored in the input history storage unit 105 (Step 408).

The third generation unit 410 generates a next input candidate 45 from the determined input 14 presented in Step 407 (Step 411). More specifically, if the determined input 14 has ordinal data, the third generation unit 410 generates next input candidate 45 from the detailed reference data that has the ordinal data following that of the determined input 14. If the determined input 14 has no ordinal data, the unit 410 generates no next input candidate 45. The receiving unit 409 waits for a candidate selection 13 that may come from the user 21.

In Step 412, whether the next input candidate exists is determined. If the next input candidate exists, the presentation unit 408 presents the next input candidate 45 generated in Step 411 (Step 413). At this point, the unit 408 may present only the next input candidate 45, not presenting the input candidate 12 containing the input 14 determined in Step 408. The process then goes from Step 413 back to Step 206, as in the case where the input candidate 12 is represented in Step 205. Note that the next input candidate 45 is not one generated in response to the input made by the user 21, but a candidate that has been estimated from the reference data. Therefore, the last input will never be found to be undetermined in Step 242. Since the next input candidate 45 has been generated for the determined input 14, the last input is found to be determined if the process goes from Step 206 to Step 209, thence to Step 241, and finally to Step 242. Then, the following steps will be performed.

As has been described, the input assistance apparatus 400 according to this embodiment generates next input candidate from the determined input made by the user, and presents the next input candidate to the user. Hence, the user can input data, by merely selecting input candidates presented to him or her, one after another.

The input assistance apparatus according to any embodiment described above can practically function by using, for example, a general purpose computer as basic hardware. In this case, the components of the input assistance apparatus cause the processor of the computer to execute programs and to use storage media such as memories and hard disks.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An input assistance apparatus, comprising:
a detection unit configured to detect input content data representing content of a user input on a user interface and input position data representing position of a user input on the user interface;
a first generation unit configured to generate from the input content data a first input candidate that has first notation data;
a first storage unit configured to store reference data for the user input, the reference data including reference data components, each reference data components including second notation data representing a notation of the reference data component and ordinal data representing a time position of the reference data component in the reference data, the second notation data being stored in association with the ordinal data;
a second storage unit configured to store an input history when the notation data about a user input made in the past is the second notation data, the input history including the notation data, the ordinal data associated with the notation data and the input position data;
an estimation unit configured to estimate a retrieval range including in part of the reference data, based on the input position data and the input history;
a second generation unit configured to retrieve, from the reference data components included in the retrieval range, at least one reference data component having the second notation data identical at least in part to the first notation data, and to generate at least one second input candidate having the ordinal data associated with the retrieved second notation data;
a presentation unit configured to select at least one input candidate from the first input candidate and second input candidate and to present to the user the selected input candidate; and
a receiving unit configured to receive a selection of a determined input from the presented input candidate coming from the user and to update the input history based on the determined input.

2. The apparatus according to claim 1, wherein the detection unit adds the input content data to a second user input, to update the input content data when the detection unit detects a second user input which follows the user input.

3. The apparatus according to claim 2, wherein the presentation unit holds the presented input candidate, until the receiving unit receives the selection; the first generation unit updates the first input candidate in accordance with the updated input content data; and the presentation unit uses the updated input content data, to update the held input candidate.

4. The apparatus according to claim 1, further comprising a third generation unit configured to generate a next input candidate from a reference data component having the ordinal data that follows the ordinal data of the determined input.

5. An input assistance apparatus, comprising:
a detection unit configured to detect a user input including input content data and input position data, each representing content and space position, respectively;
a first generation unit configured to generate from the input content data at least one first input candidate that has first notation data and first pronunciation data;
a first storage unit configured to store reference data for the user input, the reference data including reference data components, each reference data components including second notation data representing a notation of the reference data component, second pronunciation data representing a pronunciation of the reference data component and ordinal data representing a time position of the reference data component in the reference data, the second notation data and the second pronunciation data being stored in association with the ordinal data;
a second storage unit configured to store an input history when the pronunciation data about a user input made in the past is the second pronunciation data, the input history including the pronunciation data, the ordinal data associated with the pronunciation data, and the input position data;
an estimation unit configured to estimate a retrieval range including in part of the reference data, based on the input position data and the input history;
a second generation unit configured to retrieve, from the reference data components included in the retrieval range, at least one reference data component having the second pronunciation data identical at least in part to the first pronunciation data, and to generate at least one second input candidate having the retrieved second pronunciation data and the second notation data and ordinal data associated with the retrieved second pronunciation data;
a presentation unit configured to select at least one input candidate from the first input candidate and second input candidate and to present to the user the selected input candidate; and
a receiving unit configured to receive a selection of a determined input from the presented input candidate coming from the user and to update the input history based on the determined input.

6. The apparatus according to claim 5, wherein the pronunciation data is represented by phonemes.

7. The apparatus according to claim 5, wherein the detection unit adds the input content data to a second user input, to update the input content data when the detection unit detects a second user input which follows the first user input.

8. The apparatus according to claim 7, wherein the presentation unit holds the presented input candidate, until the receiving unit receives the selection; the first generation unit updates the first input candidate in accordance with the updated input content data; and the presentation unit uses the updated input content data, to update the held input candidate.

9. The apparatus according to claim 5, further comprising a third generation unit configured to generate a next input candidate from a reference data component having the ordinal data that follows the ordinal data of the determined input.

10. A computer implemented input assistance method, comprising:
detecting a user input including input content data and input position data, each representing content and space position, respectively, by a detection unit;
generating from the input content data at least one first input candidate that has first notation data, by a first generating unit;
storing reference data for the user input in a first storage unit, the reference data including reference data components, each reference data components including second notation data representing a notation of the reference data component and ordinal data representing a time position of the reference data component in the reference data, the second notation data being stored in association with the ordinal data;
storing an input history in a second storage unit when the notation data about a user input made in the past is the second notation data, the input history including the notation data, the ordinal data associated with the notation data and the input position data;
estimating a retrieval range including in part of the reference data, based on the input position data and the input history, by an estimation unit;
retrieving, from the reference data components included in the retrieval range, at least one reference data component having the second notation data identical at least in part to the first notation data, and generating at least one second input candidate having the ordinal data associated with the retrieved second notation data, by a second generating unit;
selecting at least one input candidate from the first input candidate and second input candidate and presenting to the user the selected input candidate, by a presentation unit; and
receiving a selection of a determined input from the presented input candidate coming from the user and updating the input history based on the determined input, by a receiving unit.

11. A computer implemented input assistance method, comprising:
detecting a user input including input content data and input position data, each representing content and space position, respectively, by a detection unit;
generating from the input content data at least one first input candidate that has first notation data and first pronunciation data, by a first generating unit;
storing reference data for the user input in a storage unit, the reference data including reference data components, each reference data components including second notation data representing a notation of the reference data component, second pronunciation data representing a pronunciation of the reference data component and ordinal data representing a time position of the reference data component in the reference data, the second notation data and the second pronunciation data being stored in association with the ordinal data;
storing an input history in the storage unit when the pronunciation data about a user input made in the past is the second pronunciation data, the input history including the pronunciation data, the ordinal data associated with the pronunciation data, and the input position data;
estimating a retrieval range including in part of the reference data, based on the input position data and the input history, by an estimation unit;
retrieving, from the reference data components included in the retrieval range, at least one reference data component having the second pronunciation data identical at least in part to the first pronunciation data, and generating at least one second input candidate having the retrieved second pronunciation data and the second notation data and ordinal data associated with the retrieved second pronunciation data, by a second generating unit;
selecting at least one input candidate from the first input candidate and second input candidate and presenting to the user the selected input candidate, by a presentation unit; and
receiving a selection of a determined input from the presented input candidate coming from the user and updating the input history based on the determined input, by a receiving unit.

12. A program stored in a computer readable medium having computer implemented instructions for causing a computer to perform an input assistance method, comprising:
detecting a user input including input content data and input position data, each representing content and space position, respectively;
generating from the input content data at least one first input candidate that has first notation data;
storing reference data for the user input in a storage unit, the reference data including reference data components, each reference data components including second notation data representing a notation of the reference data component and ordinal data representing a time position of the reference data component in the reference data, the second notation data being stored in association with the ordinal data;
storing an input history in the storage unit when the notation data about a user input made in the past is the second notation data, the input history including the notation data, the ordinal data associated with the notation data and the input position data;
estimating a retrieval range including in part of the reference data, based on the input position data and the input history;
retrieving, from the reference data components included in the retrieval range, at least one reference data component having the second notation data identical at least in part to the first notation data, and generating at least one second input candidate having the ordinal data associated with the retrieved second notation data;
selecting at least one input candidate from the first input candidate and second input candidate and presenting to the user the selected input candidate; and
receiving a selection of a determined input from the presented input candidate coming from the user and updating the input history based on the determined input.

13. A program stored in a computer readable medium having computer implemented instructions for causing a computer to perform an input assistance method, comprising:
detecting a user input including input content data and input position data, each representing content and space position, respectively;
generating from the input content data at least one first input candidate that has first notation data and first pronunciation data;
storing reference data for the user input in a storage unit, the reference data including reference data components, each reference data components including second notation data representing a notation of the reference data component, second pronunciation data representing a pronunciation of the reference data component and ordinal data representing a time position of the reference data component in the reference data, the second notation data and the second pronunciation data being stored in association with the ordinal data;
storing an input history in the storage unit when the pronunciation data about a user input made in the past is the second pronunciation data, the input history including the pronunciation data, the ordinal data associated with the pronunciation data, and the input position data;
estimating a retrieval range including in part of the reference data, based on the input position data and the input history;
retrieving, from the reference data components included in the retrieval range, at least one reference data component having the second pronunciation data identical at least in part to the first pronunciation data, and generating at least one second input candidate having the retrieved second pronunciation data and the second notation data and ordinal data associated with the retrieved second pronunciation data;
selecting at least one input candidate from the first input candidate and second input candidate and presenting to the user the selected input candidate; and
receiving a selection of a determined input from the presented input candidate coming from the user and updating the input history based on the determined input.
